(19) United States
(12) Patent Application Publication
(10) Pub. No.: US 2002/0010823 A1
(43) Pub. Date: Jan. 24, 2002

(54) Multimaster bus system and method for operating the multimaster bus system

(76) Inventor: Andreas Wenzel, Munchen (DE)

Correspondence Address: LERNER AND GREENBERG, P.A., Post Office Box 2480, Hollywood, FL, 33022-2480, US

(21) Appl. No.: 09/879,242

(22) Filed: Jun. 7, 2001

Related U.S. Application Data
(63) Continuation of application No. PCT/DE99/03843, filed on Dec. 1, 1999.

(30) Foreign Application Priority Data
Dec. 7, 1998 (DE) 198 56 403.1

(51) Int. Cl. G06F 13/00

(52) U.S. Cl. 710/110

(57) ABSTRACT

A multi-master bus system and a method for operating the same. The invention is characterized by a default master determination that can be dynamically modified, thereby facilitating an optimum adaptation of the bus system to the respective conditions irrespective of the circumstances. The system including the bus system can thus be quickly and efficiently operated in an optimum manner.

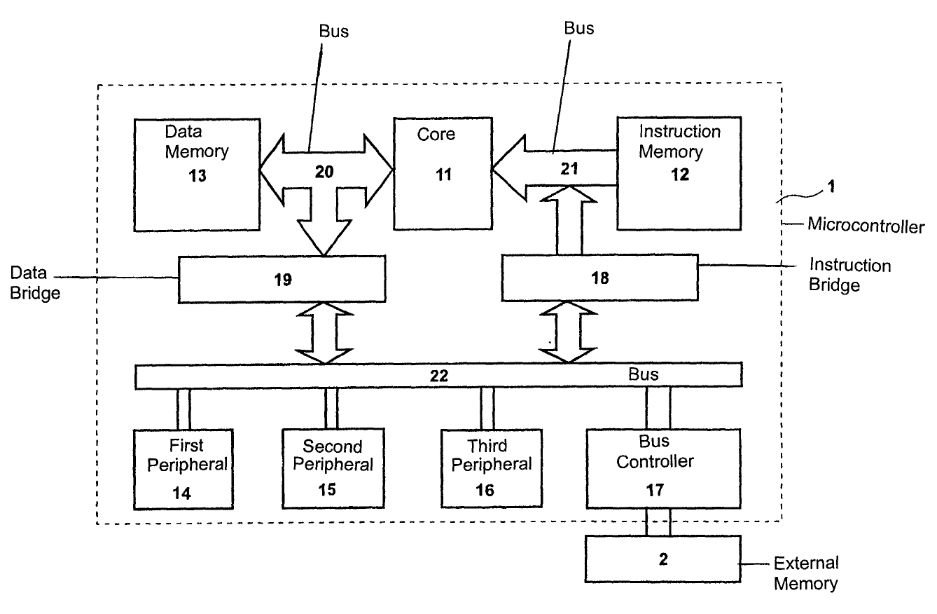

### CROSS-REFERENCE TO RELATED APPLICATION

This application is a continuation of copending International Application No. PCT/DE99/03843, filed Dec. 1, 1999, which designated the United States.

### BACKGROUND OF THE INVENTION

### Field of the Invention

The present invention relates to a multimaster bus system having a bus and units which can be connected by means of the bus, where one of the units can be stipulated as default master, and to a method for operating such a multimaster bus system.

A multimaster bus system is a bus system in which various ones of the units connected to the bus may be the bus master alternately during operation.

Of the units which can be bus master, one is usually stipulated as the default bus master or default master. This unit is the bus master whenever none of the other units are requesting the bus (want to be the bus master).

Such multimaster bus systems have been known for a long time in many different embodiments and require no more detailed explanation. The fact that various units can be the bus master alternately means that bus systems of this type can be used with great flexibility.

However, experience shows that even bus systems which can be used with such flexibility cannot always be optimally matched to the respective conditions.

### SUMMARY OF THE INVENTION

It is accordingly an object of the invention to provide a multimaster bus system and a method for operating the multimaster bus system which overcomes the above-mentioned disadvantageous of the prior art apparatus and methods of this general type. In particular, it is an object to enable the multimaster bus system to be optimally matched to the respective conditions under all circumstances.

With the foregoing and other objects in view there is provided, in accordance with the invention, a multimaster bus system, that includes: a bus; a plurality of units that can be connected using the bus; and a default master that is selected from the plurality of the units in a dynamically modifiable default-master stipulation. The default-master stipulation is based on criteria selected from the group consisting of: when the plurality of the units are used on the bus, how often the plurality of the units are used on the bus, and how long the plurality of the units are used on the bus.

With the foregoing and other objects in view there is also provided, in accordance with the invention, a multimaster bus system, that includes: a bus; a plurality of units that can be connected using the bus; and a default master that is selected from the plurality of the units in a dynamically modifiable default-master stipulation. The one of the plurality of the units that has used the bus last is stipulated as the default master in the dynamically modifiable default-master stipulation.

With the foregoing and other objects in view there is also provided, in accordance with the invention, a multimaster bus system, that includes: a bus; a plurality of units that can be connected using the bus; and a default master that is selected from the plurality of the units in a dynamically modifiable default-master stipulation. The one of the plurality of the units that needed the bus more frequently than any others of the plurality of the units in a preceding predetermined time period is stipulated as the default master in the dynamically modifiable default-master stipulation.

With the foregoing and other objects in view there is also provided, in accordance with the invention, a multimaster bus system, that includes: a bus; a plurality of units that can be connected using the bus; and a default master that is selected from the plurality of the units in a dynamically modifiable default-master stipulation. The default master is selected, in the dynamically modifiable default-master stipulation, from the group consisting of: a particular one of the plurality of the units that is expected to need to access the bus frequently, and a particular one of the plurality of the units that is expected to need to access the bus rapidly.

In accordance with an added feature of the invention, there is provided, a program-controlled unit that needs bus access. The default-master stipulation is based on an analysis selected from the group consisting of an analysis of an actual program cycle of the program-controlled unit and an analysis of an expected program cycle of the program-controlled unit.

In accordance with an additional feature of the invention, the dynamically modifiable default-master stipulation is based upon variable criteria and variable parameters.

With the foregoing and other objects in view there is also provided, in accordance with the invention, a method for operating a multimaster bus system, that includes: providing a bus and a plurality of units that can be connected using the bus; selecting a default master from the plurality of the units in a default-master stipulation that can be dynamically modified; and in the default master stipulation, selecting the default master based on criteria selected from the group consisting of: when the plurality of the units are used on the bus, how often the plurality of the units are used on the bus, and how long the plurality of the units are used on the bus.

With the foregoing and other objects in view there is also provided, in accordance with the invention, a method for operating a multimaster bus system, that includes: providing a bus and units that can be connected using the bus; selecting a default master from the plurality of the units in a default-master stipulation that can be dynamically modified; and in the default master stipulation, selecting the default master as one of the plurality of the units that has last used the bus.

With the foregoing and other objects in view there is also provided, in accordance with the invention, a method for operating a multimaster bus system, that includes: providing a bus and units that can be connected using the bus; selecting a default master from the plurality of the units in a default-master stipulation that can be dynamically modified; and in the default master stipulation, selecting the default master as one of the plurality of the units that needed the bus more frequently than any others of the plurality of the units in a preceding predetermined time period.

With the foregoing and other objects in view there is also provided, in accordance with the invention, a method for operating a multimaster bus system, that includes: providing a bus and units that can be connected using the bus; selecting a default master from the plurality of the units in a default-master stipulation that can be dynamically modified; and in the default master stipulation, selecting the default master from the group consisting of: a particular one of the plurality of the units that is expected to need to access the bus frequently, and a particular one of the plurality of the units that is expected to need to access the bus rapidly.

This means that, during operation of the bus system, various ones of the units connected thereto can be stipulated as default master alternately.

This is because the unit stipulated as the default master can generally access the bus immediately (without requesting the bus beforehand), that is to say at maximum speed.

Suitable stipulation of the default master or suitable modification of the default-master stipulation thus allows the bus system to be optimally matched to the prevailing conditions under all circumstances; this means that the system containing the bus system can operate with a maximum of speed and efficiency.

Other features which are considered as characteristic for the invention are set forth in the appended claims.

Although the invention is illustrated and described herein as embodied in a multimaster bus system and method for operating same, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWINGS

The sole drawing FIGURE is a schematic illustration of a system including a microcontroller.

### DESCRIPTION OF THE PREFERRED EMBODIMENTS

Referring now to the sole figure of the drawing in detail, there is shown a system containing a microcontroller (or other program-controlled unit, such as a microprocessor). The system includes a microcontroller 1 and an external memory 2. The microcontroller 1 includes a first bus 20, a second bus 21, and a third bus 22. The microcontroller 1 also includes a core 11, an instruction memory 12, a data memory 13, a first peripheral unit 14, a second peripheral unit 15, a third peripheral unit 16, a bus controller 17, an instruction bridge 18 (a bus protocol conversion unit) provided between the second bus 21 and the third bus 22, and a data bridge 19 (a bus protocol conversion unit) provided between the first bus 20 and the third bus 22.

The first bus 20 connects the core 11, the data memory 13 and the data bridge 19. The second bus 21 connects the core 11, the instruction memory 12 and the instruction bridge 18. The third bus 22 connects the first peripheral unit 14, the second peripheral unit 15, the third peripheral unit 16, and the bus controller 17, to the instruction bridge 18, and to the data bridge 19.

The bus controller 17 is the bus controller for an external bus provided outside the microcontroller 1. The external memory 2 (and possibly other external units) are connected to this external bus.

In the example under consideration, the external memory 2 is an external data and/or program memory for the microcontroller 1.

Instruction data required by the core 11 may optionally be fetched from the internal instruction memory 12 or from the external memory 2 via the second bus 21, the instruction bridge 18, the third bus 22 and the bus controller 17.

Data transfers prompted by the core 11 may optionally have the internal data memory 13 or the external memory 2 as the data source and/or the data destination. Data which are to be transferred between the core 11 and the external memory 2 are routed via the first bus 20, the data bridge 19, the third bus 22, and the bus controller 17.

The third bus 22 and the units connected by means of the latter form the bus system of particular interest in the present case. It is a multimaster bus system and is distinguished in that there is the possibility of dynamically setting which of the units connected by means of the bus is to be the default master.

This means that, of the units which are connected by means of the third bus 22 (first peripheral unit 14, second peripheral unit 15, third peripheral unit 16, bus controller 17, instruction bridge 18, and data bridge 19), a plurality or all of the units can be the bus master. It is possible during operation of the bus system, that is to say dynamically, to set (modify) which one of the units which can be used as the bus master is to be the default master.

The unit used as default master is the bus master if and so long as there is no bus request from the units connected by means of the bus.

The unit which is bus master at the instant at which it needs the bus has the advantage that it is able to use the bus immediately, that is to say without a prior bus request. A unit which is not the bus master at the instant at which it needs the bus must first request the bus, which means that the required bus access is delayed by at least one bus cycle. Generally, the unit which needs the bus most frequently is stipulated as the default master. The unit which needs the bus most frequently can then access the bus most rapidly on average. Such a bus system operates very efficiently.

The efficiency of such a bus system can be significantly increased with relatively little complexity by providing that the default master setting be dynamically modifiable, as in the example under consideration in the present case.

The advantages which a default master setting which can be modified dynamically (during operation of the bus system) can achieve over a fixed (not modifiable during operation) default master setting are illustrated below with the aid of the figure.

It may first be assumed that the data bridge 19 is permanently set as default master for the third bus 22. The data bridge 19 can then generally access the third bus 22 immediately when data transfer needs to be carried out between the core 11 and one of the units connected to the third bus 22. Such data transfers can therefore be carried out extremely rapidly and efficiently. By contrast, supplying instruction data stored in the external memory 2 to the core 11 is relatively complex. In order for the core 11 to be able to be supplied with instruction data requested from the external memory 2, the instruction bridge 18 needs to become bus master. Since the default master, that is to say the data bridge 19 in the example under consideration, is usually the bus master, the instruction bridge 18 first needs to request the bus. Only when the instruction bridge 18 itself is the bus master and has thus gained access to the third bus 22 is it able to transfer instruction data stored in the external memory 2 to the core 11. The request for the third bus 22, which needs to be made, delays the instruction data transfer by at least one bus cycle. In practice, fetching the data representing an instruction may also require more than one instruction data transfer. Fetching the data representing the instruction in question is then delayed even more. This is because the instruction bridge 18 needs to request the third bus 22 again for each instruction data transfer, because as soon as the instruction bridge 18 no longer requires the third bus 22, that is to say after each individual instruction data transfer, the default master, that is to say the data bridge 19, automatically becomes the bus master again. The instruction data transfer could be speeded up by stipulating the instruction bridge 18 as the default master for the third bus 22. The data transfers which need to be executed by means of the data bridge 19 could then no longer be executed as rapidly and efficiently, however.

Disadvantages of this type can be overcome by the use of a dynamically modifiable default master setting. This is because it is then possible, in each case, to stipulate as the default master, the very unit which needs the third bus particularly frequently or particularly rapidly.

Which unit is preferably stipulated as the default master at a particular instant depends on the system containing the bus system under consideration.

By way of example, default-master stipulation can be effected on the basis of past uses of the bus by the units connected thereto, for example, on the basis of when and/or how often and/or how long the individual units used the bus.

In this context, provision could be made, for example, that in each case the unit which has used the bus last is stipulated as default master. Alternatively, provision could also be made, for example, that in each case the unit which needed the bus most frequently in a predetermined preceding time period is stipulated as default master.

In addition, in each case, the unit which can be expected to have to access the bus particularly frequently and or particularly rapidly in the near future could also be stipulated as the default master. By way of example, such predictions can be made using analyses of the actual program cycle, or of that which can be expected, in the microcontroller 1 (or other program-controlled unit or subunit which needs the bus).

It ought to be clear that stipulation of the respective default master can be made dependent on any desired criteria and parameters, and it is also permissible for the criteria and parameters on the basis of which default-master stipulation is effected to be changed themselves.

Such default-master stipulation can also be used for multiprocessor systems, more precisely for a bus system which connects a plurality of program-controlled units.

The default-master stipulation described can also be used for bus systems which are not a component part of program-controlled units and/or systems containing program-controlled units.

The dynamically modifiable default-master stipulation is found to be advantageous in a number of respects: in the first instance, a bus system designed for this purpose can be optimally matched to the respective conditions under all circumstances, and in the second instance, this increases the performance of the system containing the bus system in question.

I claim:

1. A multimaster bus system, comprising:
a bus;
a plurality of units that can be connected using the bus; and
a default master that is selected from the plurality of the units in a dynamically modifiable default-master stipulation;
the default-master stipulation being based on criteria selected from the group consisting of:
when the plurality of the units are used on the bus,
how often the plurality of the units are used on the bus, and
how long the plurality of the units are used on the bus.

2. A multimaster bus system, comprising:
a bus;
a plurality of units that can be connected using the bus; and
a default master that is selected from the plurality of the units in a dynamically modifiable default-master stipulation;
one of the plurality of the units that has used the bus last being stipulated as the default master in the dynamically modifiable default-master stipulation.

3. A multimaster bus system, comprising:
a bus;
a plurality of units that can be connected using the bus; and
a default master that is selected from the plurality of the units in a dynamically modifiable default-master stipulation;
one of the plurality of the units that needed the bus more frequently than any others of the plurality of the units in a preceding predetermined time period being stipulated as the default master in the dynamically modifiable default-master stipulation.

4. A multimaster bus system, comprising:
a bus;
a plurality of units that can be connected using the bus; and
a default master that is selected from the plurality of the units in a dynamically modifiable default-master stipulation;
the default master selected, in the dynamically modifiable default-master stipulation, from the group consisting of:
a particular one of the plurality of the units that is expected to need to access the bus frequently, and
a particular one of the plurality of the units that is expected to need to access the bus rapidly.

5. The multimaster bus system according to claim 4, comprising:
a program-controlled unit that needs bus access;
the default-master stipulation being based on an analysis selected from the group consisting of an analysis of an actual program cycle of the program-controlled unit and an analysis of an expected program cycle of the program-controlled unit.

6. The multimaster bus system according to claim 4, wherein the dynamically modifiable default-master stipulation is based upon variable criteria and variable parameters.

7. A method for operating a multimaster bus system, which comprises:
providing a bus and a plurality of units that can be connected using the bus;
selecting a default master from the plurality of the units in a default-master stipulation that can be dynamically modified; and
in the default master stipulation, selecting the default master based on criteria selected from the group consisting of:
when the plurality of the units are used on the bus,
how often the plurality of the units are used on the bus, and
how long the plurality of the units are used on the bus.

8. The method according to claim 7, which comprises varying criteria and varying parameters upon which the default-master stipulation is based.

9. A method for operating a multimaster bus system, which comprises:
providing a bus and a plurality of units that can be connected using the bus;
selecting a default master from the plurality of the units in a default-master stipulation that can be dynamically modified; and
in the default master stipulation, selecting the default master as one of the plurality of the units that has last used the bus.

10. The method according to claim 9, which comprises varying criteria and varying parameters upon which the default-master stipulation is based.

11. A method for operating a multimaster bus system, which comprises:
providing a bus and a plurality of units that can be connected using the bus;
selecting a default master from the plurality of the units in a default-master stipulation that can be dynamically modified; and
in the default master stipulation, selecting the default master as one of the plurality of the units that needed the bus more frequently than any others of the plurality of the units in a preceding predetermined time period.

12. The method according to claim 11, which comprises varying criteria and varying parameters upon which the default-master stipulation is based.

13. A method for operating a multimaster bus system, which comprises:
providing a bus and a plurality of units that can be connected using the bus;
selecting a default master from the plurality of the units in a default-master stipulation that can be dynamically modified; and
in the default master stipulation, selecting the default master from the group consisting of:
a particular one of the plurality of the units that is expected to need to access the bus frequently, and
a particular one of the plurality of the units that is expected to need to access the bus rapidly.

14. The method according to claim 13, which comprises varying criteria and varying parameters upon which the default-master stipulation is based.

15. The method according to claim 13, which comprises:
in the default master stipulation, selecting the default master based on an analysis selected from the group consisting of an analysis of an actual program cycle in a program-controlled unit which needs bus access, and
an analysis of an expected program cycle in the program-controlled unit.

16. The method according to claim 15, which comprises varying criteria and varying parameters upon which the default-master stipulation is based.
